(19) United States
(12) Patent Application Publication
(10) Pub. No.: US 2010/0332810 A1
(43) Pub. Date: Dec. 30, 2010

(54) Reconfigurable Functional Unit Having Instruction Context Storage Circuitry To Support Speculative Execution of Instructions

(76) Inventors: Tao Wang, Beijing (CN); Zhihong Yu, Hillsboro, OR (US); Joel S. Emer, Acton, MA (US); Yuan Liu, Beijing (CN); Peng Li, Beijing (CN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/495,604

(22) Filed: Jun. 30, 2009

(51) Int. Cl. G06F 9/30

(52) U.S. Cl. 712/228; 712/E09.016

(57) ABSTRACT

A functional unit is described. The functional unit includes a reconfigurable logic circuitry and instruction context storage circuitry to store instruction context information generated from instructions executed by the reconfigurable logic circuitry within the reconfigurable functional unit. The instructions include speculatively executed instructions.

### FIELD OF INVENTION

The field of invention relates generally to the computing sciences, and, more specifically, to reconfigurable functional units.

### BACKGROUND

FIG. 1 shows a simplistic view of a processor 100. A processor, such as a general purpose processor or special purpose processor, is a semiconductor chip having electronic circuitry designed to process program code instructions. Most processors typically include a number of common architectural features. For example, many different types of processors include (not shown in FIG. 1): i) a cache to locally store instructions and/or data; ii) fetch circuitry to fetch instructions from cache and/or memory; iii) registers to store instruction input operands and instruction output results; and, iv) write-back circuitry to store instruction results into cache and/or memory.

The specific portions of a processor's electronic circuitry that actually execute program code instructions are typically referred to as “functional units” 101. Functional units 101 essentially include the circuitry used to perform the specific operations that the program code instructions specify or otherwise include. For instance, in order to support the execution of an ADD instruction, a processor may include a functional unit having circuitry that adds two operands together. Processors often include a plurality of such functional units in order to implement a multitude of supported program code instructions that are referred to as the processor's “instruction set”.

Traditionally, a processor's instruction set is specific and defined at the moment of its manufacture. As such, functional units 101 have traditionally been implemented with “hardwired” logic circuitry that is manufactured to only support the processor's specific, pre-defined instruction set. There has been interest, however, in processors that permit at least some of the instructions within their respective instruction sets to be defined after the processor is manufactured.

In order to construct such a processor, one or more of the functional units within the processor are made with “reconfigurable” logic circuitry. Reconfigurable logic circuitry is circuitry whose logic function(s) can be defined after the circuitry is manufactured. Examples of such circuitry include circuitry found in Field Programmable Gate Arrays (FPGAs), Programmable Logic Devices (PLDs) and Programmable Logic Arrays (PLAs). Additionally, in micro-coded machines, the micro-code may be externally exposed so it can be programmed (e.g., by a user). In the case of externally exposed microcode, a reconfigurable functional unit may include and/or be coupled to circuitry that receives the external microcode. Reconfigurable logic circuitry may also include paths through chains of logic circuits that are established/configured with enable/disable lines. Such circuits at least permit processors who can configure or change their instruction sets “on-the-fly” during operation.

FIG. 2 shows a simplistic view of a processor 200 having some hardwired functional units 201 and some reconfigurable functional units 202.

A matter of concern, however, with processors having reconfigurable functional units is the design of instruction “context” circuitry. Instruction context circuitry is circuitry that holds intermediate values between instructions. For example, a Multiply-Accumulate (MAC) instruction typically multiplies an input operand A to another input operand B and adds the result to a stored value C. The result is stored so as to replace the stored value C. A sequence of MAC instructions will continually update the stored value C. Here, the stored value C can be viewed as context of the sequence of the MAC instructions. Depending on implementation, including instruction context circuitry within a processor may provide a boost to processor performance because it may avoid time penalties for fetching the intermediate value from remote instruction operand/result storage space.

Processors often are designed to speculatively execute instructions (as an example, FIG. 2 shows a processor having a branch prediction unit 203). Here, upon recognizing the existence of a branch instruction waiting to be executed, a processor with branch prediction will make an educated guess at what the branch decision will be upon its actual execution. In view of this guess, the processor will then proceed to speculatively execute the sequence of instructions that naturally follow the guessed branch decision. In cases where the wrong branch is predicted one or more of the speculative instructions may be incorrect. In this case, the processor needs to restore previous variable state information (including instruction context information) to its most recent “correct” state. It is worth mentioning that other architectures may cause a flow of speculatively executed instructions to flow through a functional unit. For example, in the case of “thread level parallelism” (TLP), a sequence of serial code is divided into several parts and executed in parallel. If the division is “incorrect” the code is re-executed (thus the previous executions were speculative). In the case of “value prediction”, the processor predicts a data value (not necessarily a value that a branch is based upon) and speculatively executes instructions based on the predicted data value.

The design of reconfigurable processors may raise issues concerning the implementation of the instruction context for the reconfigurable functional units. Specifically, because the instances of speculative context updates is large/unknown, the amount of instruction context storage space (and therefore the size of the instruction context circuitry) can be unreasonably large. Therefore, designs that effectively limit the size of the instruction context circuitry for the reconfigurable logic are currently of interest.

### BRIEF DESCRIPTION OF THE DRAWINGS

The present invention is illustrated by way of example and not limitation in the figures of the accompanying drawings, in which like references indicate similar elements and in which:

FIG. 1 shows a traditional processor;

FIG. 2 shows a processor having reconfigurable functional units;

FIGS. 3a through 3j show structure and operation of a first reconfigurable functional unit embodiment;

FIGS. 4a through 4c show methods performed by the first reconfigurable functional unit of FIGS. 3a through 3j;

FIGS. 5a through 5g show structure and operation of a second reconfigurable functional unit embodiment;

FIG. 6 shows a methodology performed by the second reconfigurable functional unit of FIGS. 5a through 5g;

FIG. 7 shows an embodiment of a computing system.

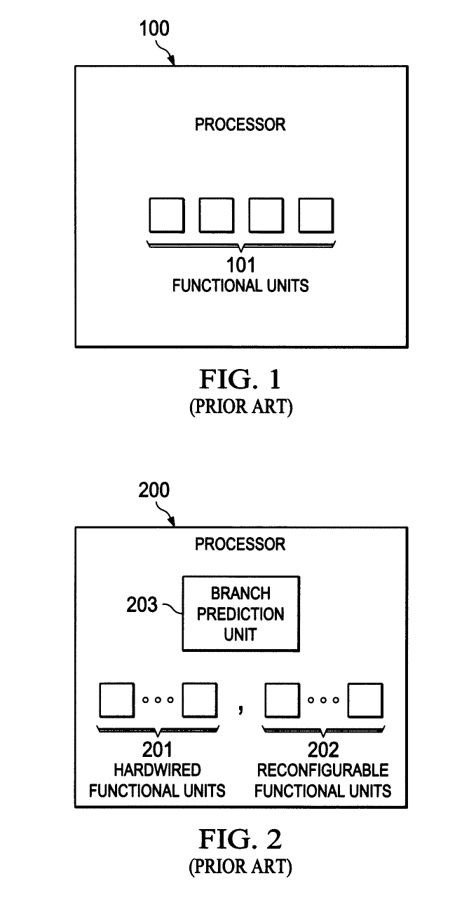

### DETAILED DESCRIPTION

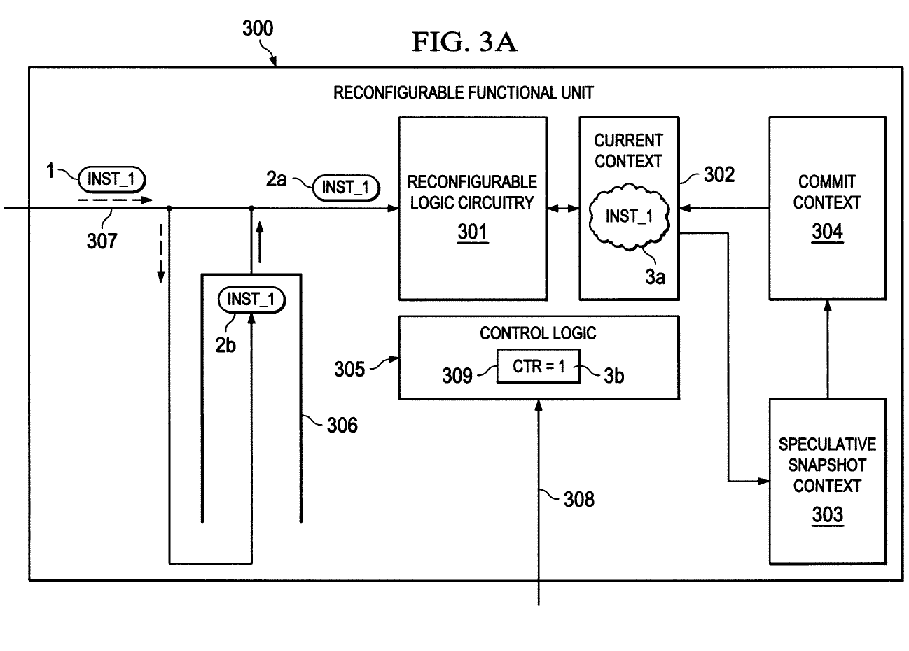

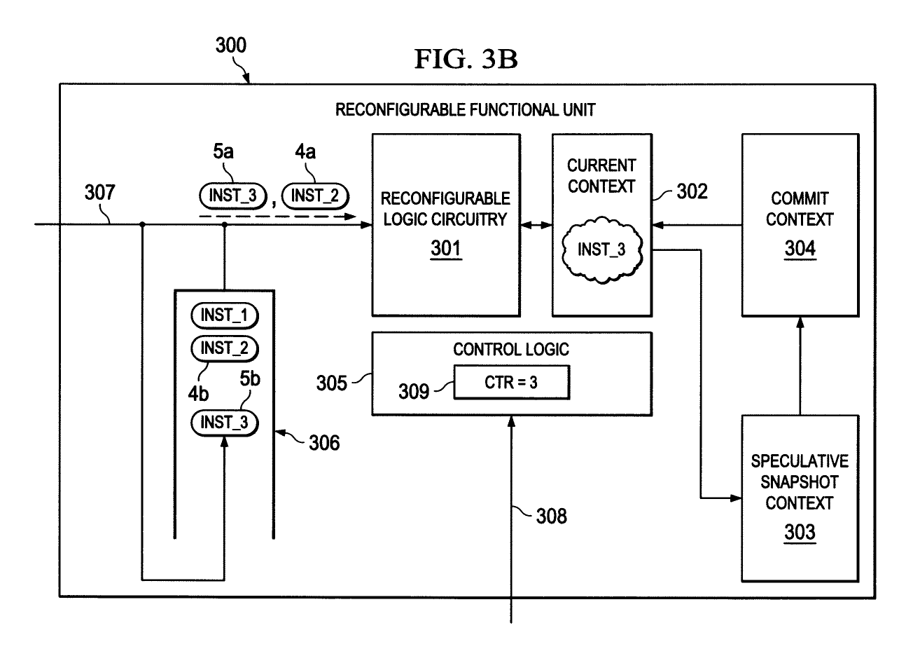

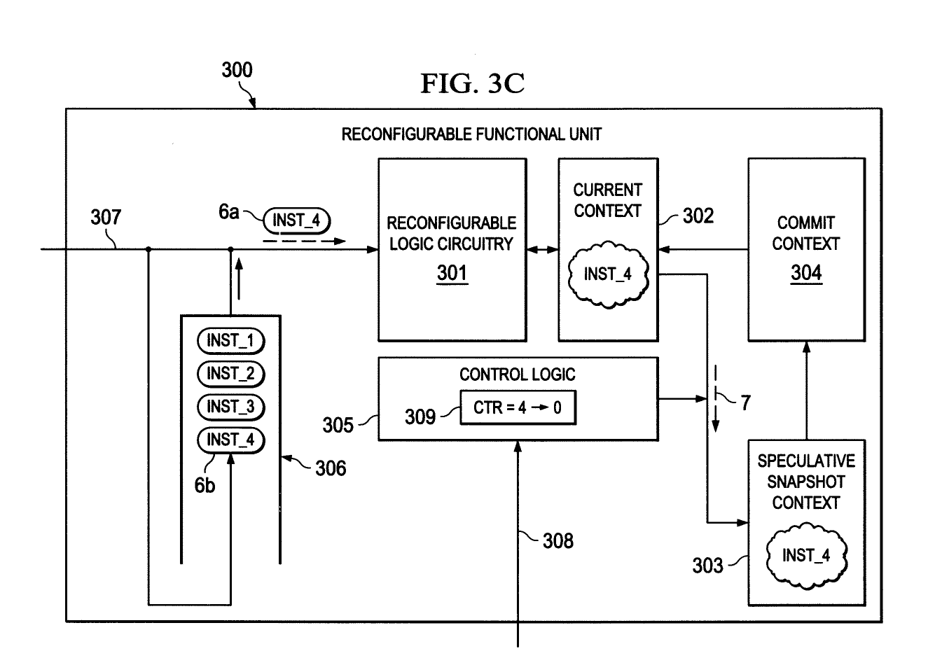

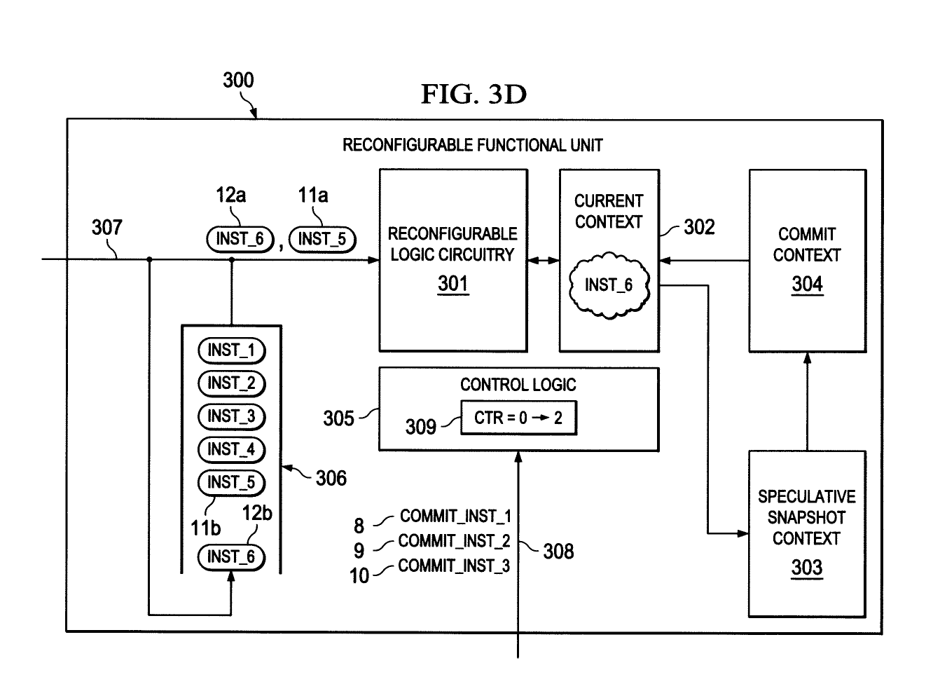

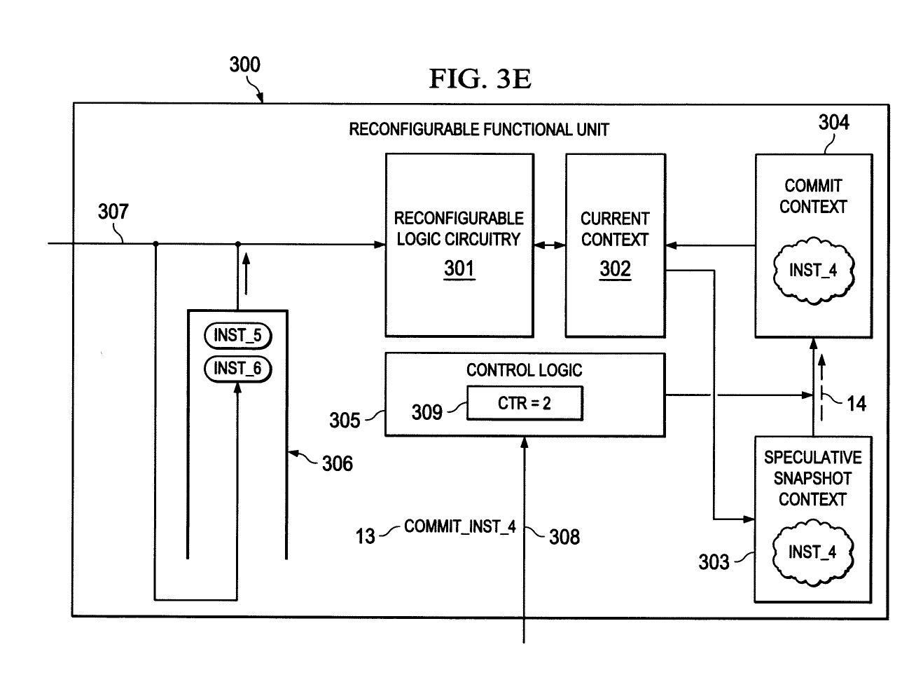

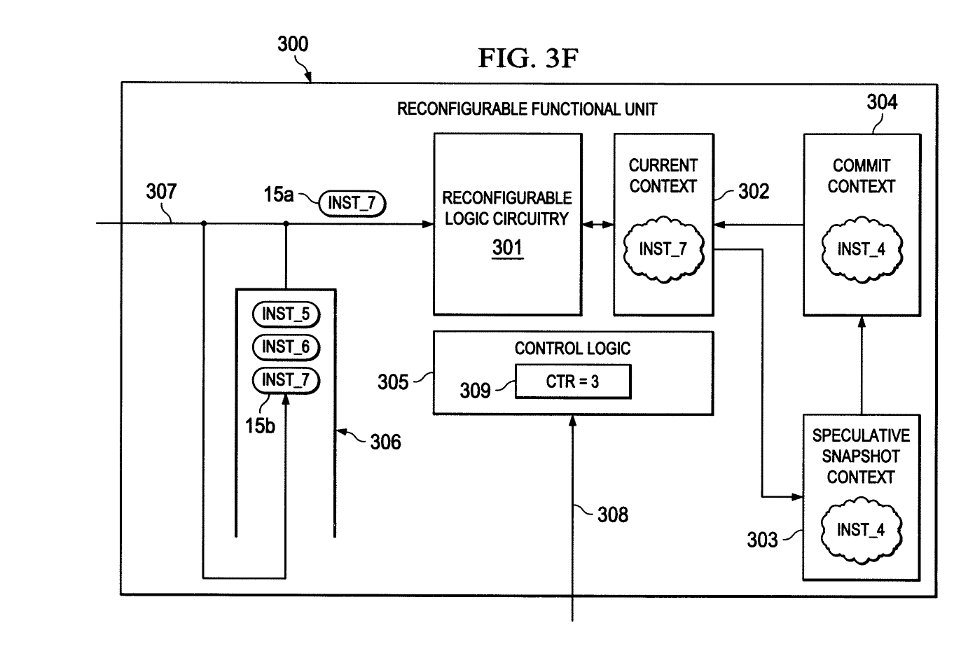

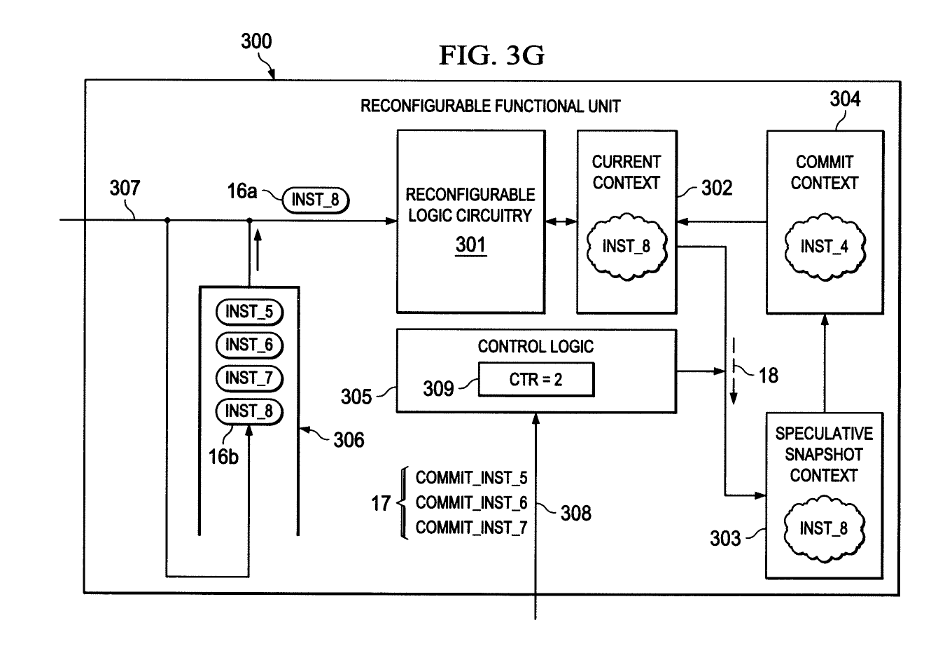

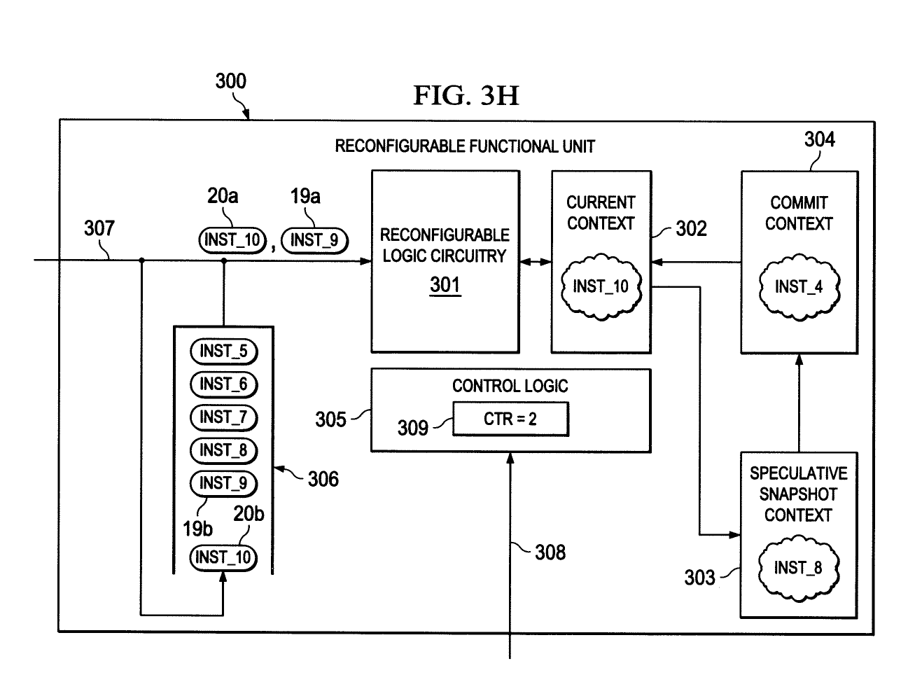

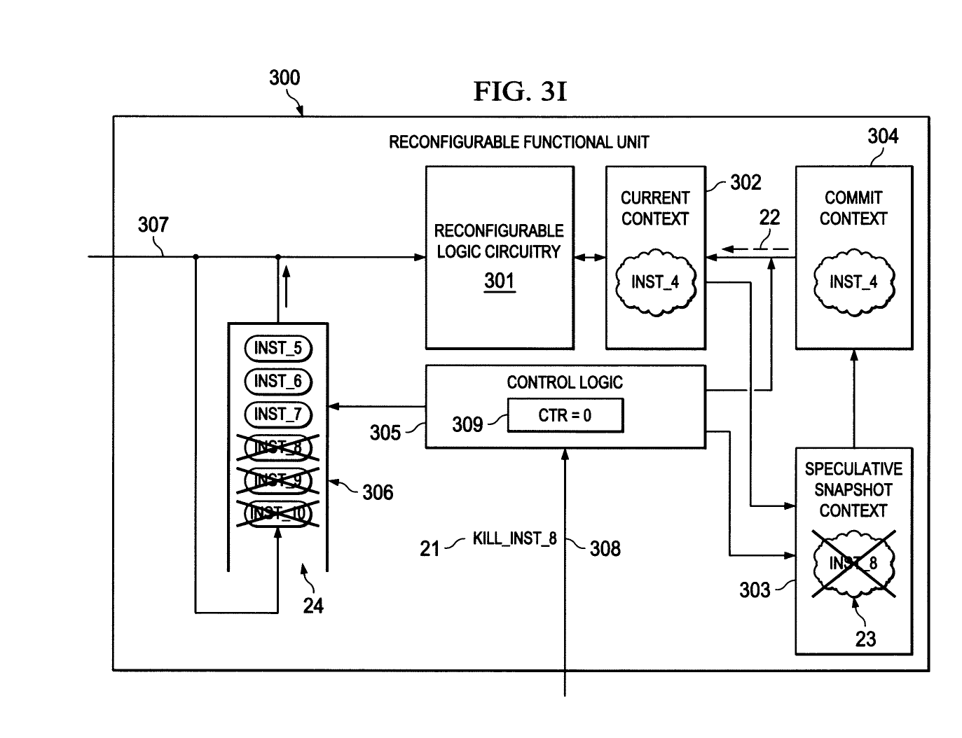

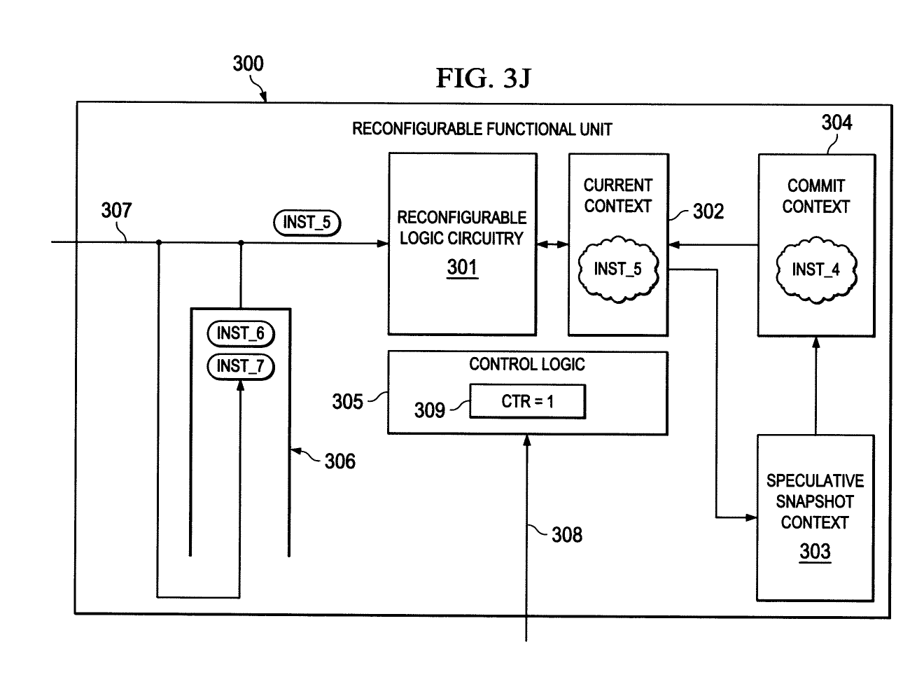

FIGS. 3a through 3j show a design and operation of a reconfigurable functional unit 300 that addresses the issues of instruction context size and restoration. Referring to FIG. 3a, the reconfigurable functional unit 300 includes: 1) reconfigurable logic circuitry 301; 2) current instruction context storage circuitry 302; 3) speculative instruction context storage circuitry 303; 4) committed instruction context storage circuitry 304; 5) control logic circuitry 305; and, 6) an instruction queue 306.

As will be described in more detail below, as instructions are executed by the reconfigurable logic circuitry 301, the current instruction context 302 is frequently updated. Each time a specific number (K) of consecutive instructions have been executed, the speculative context 303 is updated with the contents of the current context 302. For example, if K=4, each time four instructions are executed the speculative context 303 is updated with the contents of the current context 302. The use of the speculative 303 and committed contexts 304 efficiently permits “rollback” to a previous context state when a series of incorrect instructions have been executed as a consequence of an incorrect branch prediction. As will be more clear further below, designing the functional unit 300 according to this approach helps prevent the size of the instruction context circuitry from reaching unreasonable proportions. Notably, the functional unit of FIG. 3 is believed to be workable with various architectures that employ speculative execution (e.g., branch prediction, thread level parallelism, value prediction, etc.).

The operation of the reconfigurable functional unit will presently be described. Referring to FIG. 3a, a first instruction (INST_1) to be executed is presented at input 307. Here, processor logic circuitry not shown in FIG. 3a determines the sequence of instructions that the reconfigurable functional unit 300 is to execute. These instructions are presented at input 307 and can include speculative instructions that are based on a branch prediction. Additional processor logic circuitry not shown in FIG. 3a determines whether the instructions executed by the reconfigurable functional unit 300 are correct or incorrect (e.g., in view of a previous branch prediction). The reconfigurable functional unit 300 is informed of the correct/incorrect status of each instruction that it executes at input 308. Here, in an embodiment, the reconfigurable functional unit receives a “commit” message at input 308 for those instructions that should have been executed, and, receives a “kill” message at input 308 for those instructions that should not have been executed. As will be clear in the following discussion, the control logic circuitry 305 controls the content of the context storage areas 302, 303 and 304 and ensures correct execution of committed instructions through the functional unit in view of the “commit” and “kill” messages.

Upon the reception 1 of the first instruction INST_1 at input 307, the instruction is: i) presented 2a to the reconfigurable logic circuitry 301; and, ii) entered 2b in the instruction queue 306. The reconfigurable logic circuitry 301 implements the logic functions of the functional unit 301 and executes INST_1. With the execution of INST_1 the current context 302 is updated 3a and counter 309 maintained by the control logic 305 is incremented 3b from a value of 0 to a value of 1.

Next, as depicted in FIG. 3b, second and third instructions INST_2 and INST_3 are received at input 307, executed by the reconfigurable logic circuitry 301 and stored in the instruction queue 306 4a/b, 5a/b. After execution of INST_3, the current context 302 reflects the context state after execution of INST_3 and the counter 309 is incremented to a value of 3.

Next, as depicted in FIG. 3c, a fourth instruction INST_4 is received at input 307, executed by the reconfigurable logic circuitry 301 and stored in the instruction queue 306 6a/b. After execution of INST_4, the current context 302 reflects the context state after execution of INST_4 and the counter is incremented to a value of 4. In this example, the control logic circuitry 305 is designed to trigger an update of the speculative context 303 when the counter reaches a value of 4 (i.e., after the execution of four consecutive instructions). As such, upon execution of INST_4, the speculative context 303 is updated 7 with the contents of the current context 302. Here, in an embodiment, the control logic circuitry 305 recognizes that the speculative context 303 reflects the execution of INST_4 and therefore attributes INST_4 as the “owner of the snapshot”. The counter 309 is reset from a value of 4 to a value of 0.

Next, as depicted in FIG. 3d, the control logic circuitry 305 receives 8, 9, 10 “commit” messages at input 308 for instructions INST_1, INST_2, INST_3. As will be more clear further below, the control logic circuitry is designed to: 1) update the commit context 304 with the contents of the speculative context 303 if a “commit” message is received for the owner of the snapshot (in this example, INST_4); or, 2) update the current context 302 with the contents of the commit context 304 if a “kill” message is received for an earlier executed instruction. Because the reception of commit messages for INST_1, INST_2 and INST_3 do not trigger either of these conditions the control logic circuitry 305 takes no action as of FIG. 3d.

FIG. 3d also shows the arrival, queuing and execution 11a/b, 12a/b of instructions INST_5 and INST_6. As such, FIG. 3d also shows that the current context 302 reflects the execution of INST_6. The counter 309 therefore increments from a value of 0 to a value of 2.

As depicted in FIG. 3e, the control logic circuitry 305 receives 13 a “commit” message for INST_4. Because INST_4 is the owner of the snapshot, as described just above, the control logic circuitry updates 14 the commit context 304 with the contents of the speculative context 303, and, because the execution of INST_1, INST_2, INST_3 and INST_4 are now reflected in the commit context 304, the control logic circuitry 305 also deletes INST_1, INST_2, INST_3 and INST_4 from the instruction queue 306 leaving only instructions INST_5 and INST_6. At this point, the functional unit essentially recognizes that the execution of instructions INST_1 through INST_4 is “correct” and the state of the instruction context up through INST_4 is “committed” as reflected in the commit context 304.

It is important to note that although the specific example discussed so far shows the commit messages for INST_1 through INST_4 beginning to arrive after execution of INST_1 through INST_4 no such restriction concerning the timing of the arrival of the messages received at input 308 vs. the arrival of the instructions received at input 307 is required. For instance, the commit message for INST_1 could have arrived at input 308 before INST_2 was received at input 307.

Next, as depicted in FIG. 3f, INST_7 is received at input 307, entered in queue 306 and executed 15a/b. As such, the current context 302 reflects state information as of the instruction of INST_7 and the speculative and commit contexts 303 and 304 reflect execution as of INST_4. The counter 309 increments to a value of 3.

Next, as depicted in FIG. 3g, INST_8 is received at input 307, entered in queue 306 and executed 16a/b. Also, commit messages are received 17 for INST_5, INST_6 and INST_7 at input 308. The execution of INST_8 causes the counter to be incremented to a value of 4, which, in turn cause the snapshot context 303 to be updated 18 with the contents of the current context 302. The counter is reset to a value of 0.

Next, as depicted in FIG. 3h, INST_9 and INST_10 are received at input 307, entered in queue 306 and executed 19a/b, 20a/b. As such, the current context 302 reflects the state of execution through INST_10.

Next, as depicted in FIG. 3i, a KILL message is received 21 for INST_8 at input 308. The KILL message may be created, for instance, because the processor has recognized that an incorrect branch decision was made. In response to the KILL message, the control logic circuitry 305 loads 22 the current context 302 with the contents of the commit context 304, deletes 23 the contents of the speculative snapshot context and deletes 24 from the instruction queue 306 INST_8 and the instructions that arrived after INST_8 (i.e., INST_9 and INST_10), while, keeping in the instruction queue 306 the instructions that precede INST_8 (i.e., INST_5, INST_6 and INST_7). With the current context 302 now reflecting operation through INST_4, and, INST_5, INST_6 and INST_7 waiting in the instruction queue, the functional unit has essentially rolled itself back to a state that existed prior to the execution of INST_5. The counter 309 is also cleared.

From this state, as depicted in FIG. 3j, INST_5 is executed and the machine continues forward.

In an embodiment, the commit context 304 cannot be updated if the speculative snapshot context 303 content's are cleared. Alternatively, the clearing of the context 23 in FIG. 3i is technically not necessary so long as there are guarantees that the stale speculative context state of FIG. 3h is not written into the commit context 304.

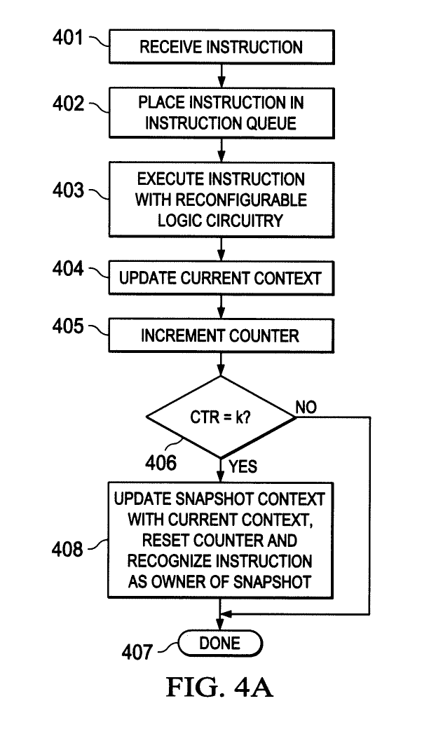

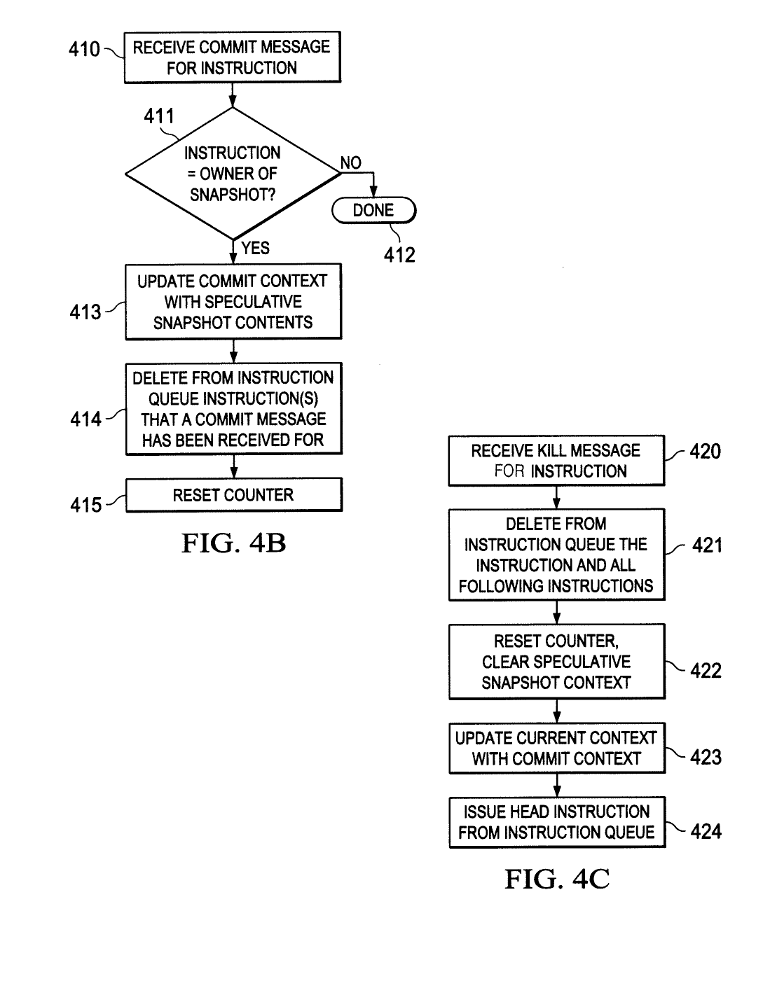

FIGS. 4a through 4c highlight some of the processes discussed above. Referring to FIG. 4a, when an instruction is received 401, the instruction is placed 402 in an instruction queue and executed 403 with reconfigurable logic circuitry. As a consequence of the instruction's execution, the current context is updated 404 and the counter is incremented 405. If the counter's vale meets a preset value (K), the speculative snapshot is updated, the counter is cleared and the instruction is recognized as the owner of the snapshot 408, otherwise the process is complete 407.

Referring to FIG. 4b, when a commit message is received 410 for an instruction, if the instruction is the owner of the snapshot 411, the commit context is updated with the contents of the speculative snapshot context 413, and, the instruction(s) within the instruction queue (including the instruction) for whom commit messages have been received are deleted from the instruction queue 414. The counter is also reset 415. If the instruction is not the owner of the snapshot the process is complete 412.

Referring to FIG. 4c, if a KILL message is received for an instruction 420, the instruction and any additional instruction(s) that follow the instruction are deleted from the instruction queue 421. The counter is reset 422 and the speculative snapshot may be optionally cleared. The current context is updated with the contents of the commit context 423. The instruction at the head of the instruction queue 424 is then issued.

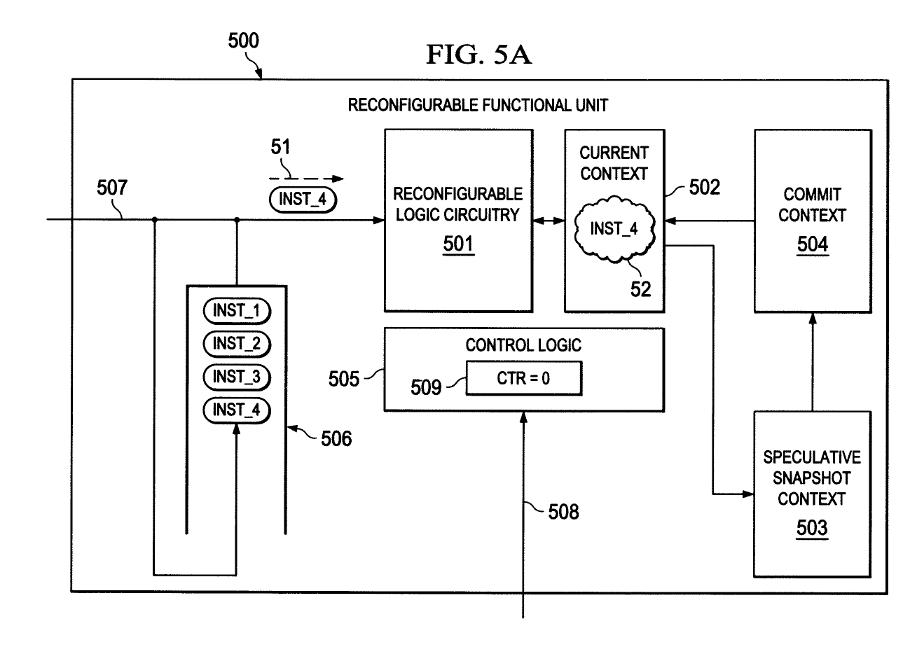

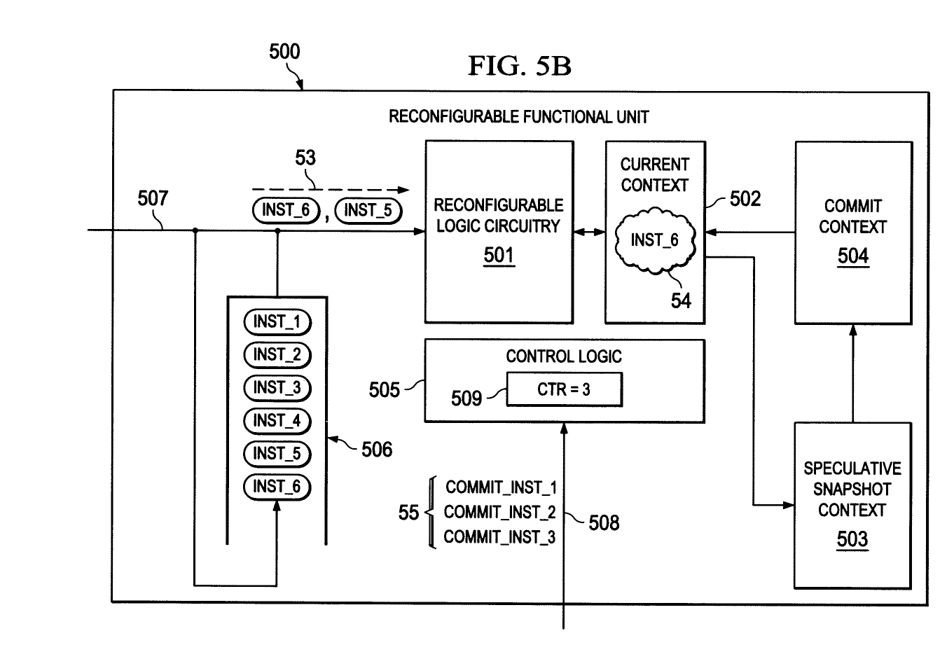

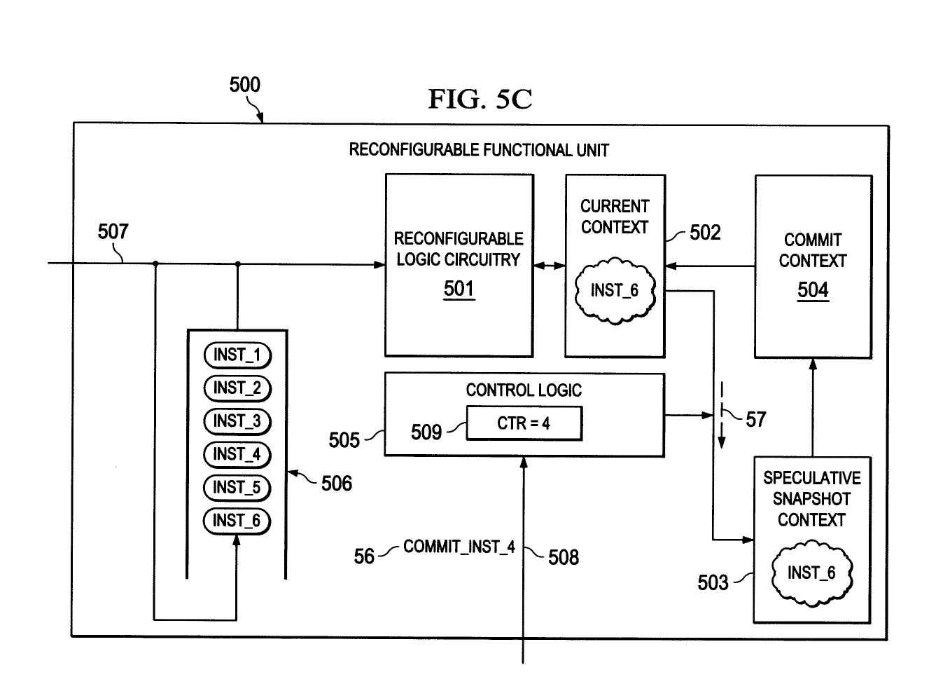

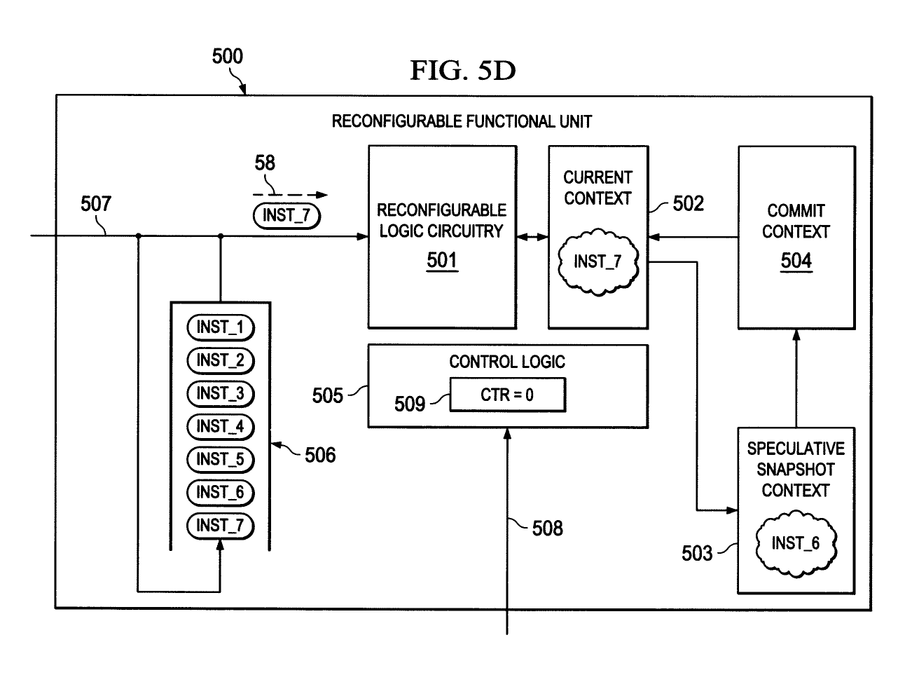

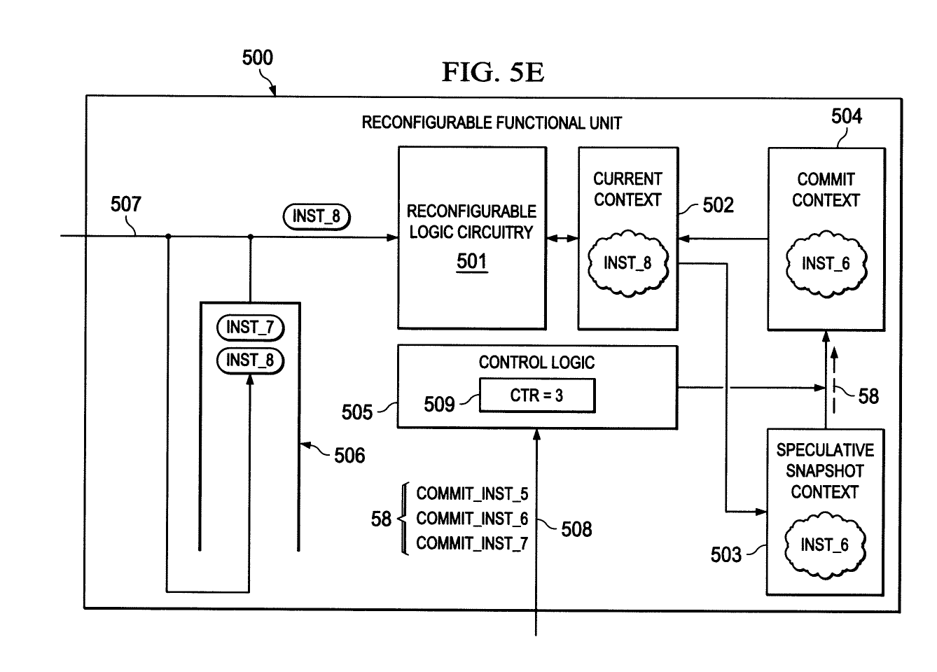

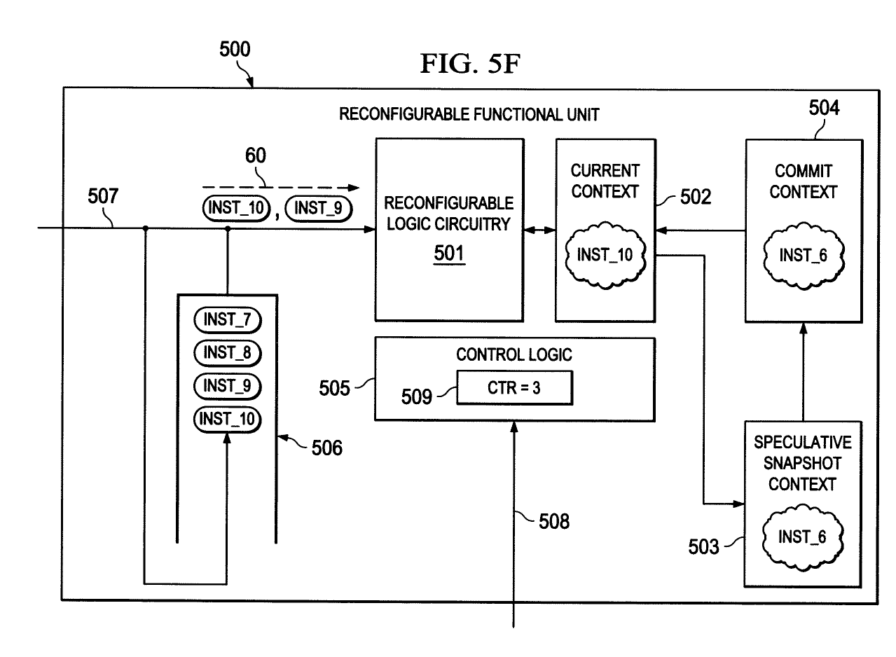

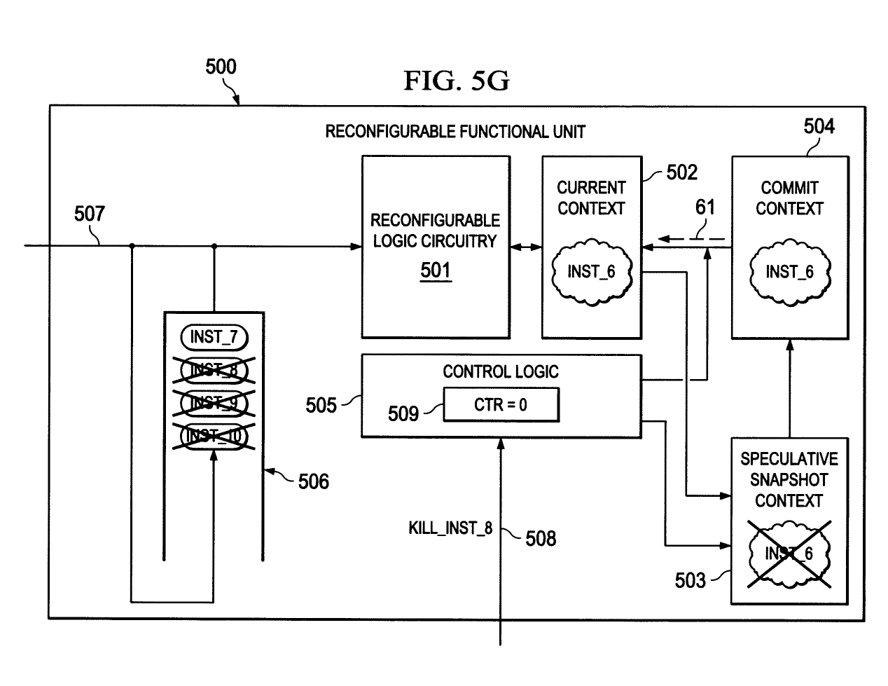

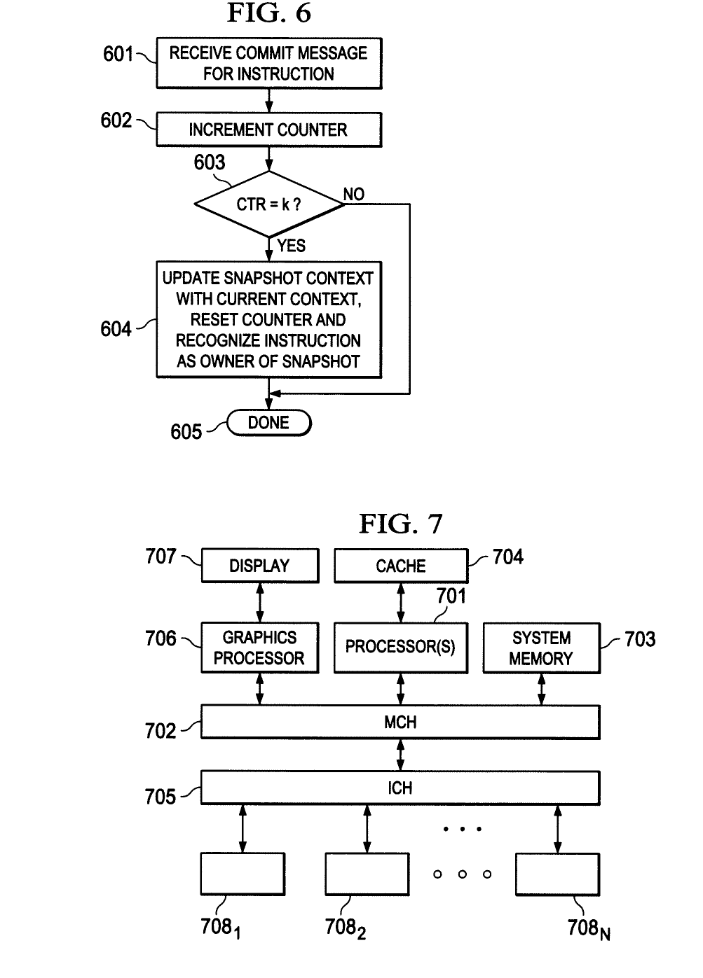

FIGS. 3a through 3j and 4a through 4c described an embodiment in which the counter was incremented after execution of an instruction. By contrast, FIGS. 5a through 5g and 6 relate to an embodiment in which the counter is incremented after a commit message is received.

FIG. 5a shows the state of the reconfigurable functional unit as it existed in FIG. 3c above with the arrival 51 of INST_4. The arrival of INST_4 causes the entry of INST_4 into the instruction queue 506 and the execution of the INST_4 by the reconfigurable logic circuitry. As such, the state 52 of the current context 502 reflects execution up though INST_4. Note that, unlike the aforementioned embodiment, the counter 509 is at zero after the arrival and execution of instructions INST_1 through INST_4.

FIG. 5b shows the arrival 53 of instructions INST_5 and INST_6. As such, the instruction queue includes instructions INST_5 and INST_6 and the current context 502 reflects execution through INST_6. FIG. 5b also shows the arrival of commit messages 55 for INST_1 through INST_3. The arrival of these commit messages causes the counter 509 to increment to a value of three.

FIG. 5c shows the arrival 54 of the commit message for INST_4. The arrival of the commit message for INST_4 causes the counter to increment to a value of 4 which, in turn, causes the speculative context 503 to be updated 57 with the contents of the current context 502 which reflects execution through INST_6. As such, INST_6 is the owner of the speculative snapshot. Note the difference with FIG. 3c which shows INST_4 as the owner of the speculative snapshot.

FIG. 5d shows the arrival 58 of INST_7. With the arrival of INST_7, INST_7 is entered in the instruction queue 506 and is executed. As such, the current context 502 reflects the state of the current context 502 after execution of INST_7. Note the counter 509 has been reset to a value of zero with the update of the speculative context from FIG. 5c.

FIG. 5e shows the arrival 58 of the commit messages for instructions INST_5, INST_6 and INST_7. The arrival of these messages causes the counter 509 to increment to a value of three. Also, the arrival of the commit message for instruction INST_6 corresponds to the arrival of the owner of the speculative snapshot. As such, the commit context 504 is updated 59 with the contents of the speculative context 503 reflecting execution through INST_6. Instructions INST_1 through INST_6 are also removed from the instruction queue 506. FIG. 5e also shows the arrival of INST_8. As such, the instruction queue 506 includes INST_7 and INST_8 and the current context 502 reflects execution through INST_8.

FIG. 5f shows the arrival 60 of instructions INST_9 and INST_10. As such, the instruction includes INST_7 though INST_10 and the current context 502 reflects execution through INST_10.

FIG. 5g shows the arrival of a kill message for INST_8. The arrival of the kill message causes: i) the current context 502 to be updated 61 with the contents of the commit context 504; and, ii) the removal from the instruction queue 506 of INST_8 and any instructions that arrived after INST_8. As such, from i) above, the current context now reflects execution through INST_6 and, from ii) above, the instruction queue only includes INST_7. The speculative context may be cleared or may keep its current state. From this state, re-execution of INST_7 can begin.

FIG. 6 shows the methodology for updating the counter with the arrival of a commit message (FIGS. 4b and 4c still describe operation of the functional unit of FIGS. 5a through 5g). According to the methodology of FIG. 6, when a commit message is received for an instruction 601, a counter is incremented 602. If the counter reaches a value K 603, the speculative snapshot is updated with the contents of the current context and the instruction that the current context reflects execution through is recognized as the owner of the speculative snapshot 604.

Comparing the embodiment of FIGS. 3a through 3j (increment counter w/instruction execution) with the embodiment of FIGS. 5a though 5g (increment counter w/commit message receipt), it is believed that the later approach (increment counter w/commit message) may be more efficient because the former approach (increment counter w/executed instructions) can update the speculative context with non committed instructions just as easily as committed instructions. Because the update of the speculative context may represent a form of processing “expense” it is generally believed that directing such expense more to committed instructions rather than non committed instructions can be more efficient. Incrementing the counter with the receipt of commit instructions leans toward this objective.

It is also worthwhile to note that after the owner of the snapshot is established and the counter is reset, the counter, in some circumstances, may reach K before the commit message for the owner of the snapshot is received. In this case, the snapshot context is updated, the counter is reset to zero and the owner of the snapshot is reset to the instruction through which execution of the current (and now speculative) context includes execution through. Continued occurrences of this effect may lessen performance as it reduces the rate at which the commit context is updated. In order to reduce/eliminate this penalty, one approach is to not reset the counter to zero when the speculative context is updated. Rather, set the counter to a “pending” state and only set it to zero if the commit message or a KILL message for the original snapshot owner is received.

FIG. 7 shows an embodiment of a computing system (e.g., a computer). The exemplary computing system of FIG. 7 includes: 1) one or more processors 701 at least one of which may include features described above; 2) a memory control hub (MCH) 702; 3) a system memory 703 (of which different types exist such as DDR RAM, EDO RAM, etc); 4) a cache 704; 5) an I/O control hub (ICH) 705; 6) a graphics processor 706; 7) a display/screen 707 (of which different types exist such as Cathode Ray Tube (CRT), Thin Film Transistor (TFT), Liquid Crystal Display (LCD), DPL, etc.; 8) one or more I/O devices 708.

The one or more processors 701 execute instructions in order to perform whatever software routines the computing system implements. The instructions frequently involve some sort of operation performed upon data. Both data and instructions are stored in system memory 703 and cache 704. Cache 704 is typically designed to have shorter latency times than system memory 703. For example, cache 704 might be integrated onto the same silicon chip(s) as the processor(s) and/or constructed with faster SRAM cells whilst system memory 703 might be constructed with slower DRAM cells. By tending to store more frequently used instructions and data in the cache 704 as opposed to the system memory 703, the overall performance efficiency of the computing system improves.

System memory 703 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 703 prior to their being operated upon by the one or more processor(s) 701 in the implementation of a software program. Similarly, data that a software program determines should be sent from the computing system to an outside entity through one of the computing system interfaces, or stored into an internal storage element, is often temporarily queued in system memory 703 prior to its being transmitted or stored.

The ICH 705 is responsible for ensuring that such data is properly passed between the system memory 703 and its appropriate corresponding computing system interface (and internal storage device if the computing system is so designed). The MCH 702 is responsible for managing the various contending requests for system memory 703 access amongst the processor(s) 701, interfaces and internal storage elements that may proximately arise in time with respect to one another.

One or more I/O devices 708 are also implemented in a typical computing system. I/O devices generally are responsible for transferring data to and/or from the computing system (e.g., a networking adapter); or, for large scale non-volatile storage within the computing system (e.g., hard disk drive). ICH 705 has bidirectional point-to-point links between itself and the observed I/O devices 708.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A semiconductor chip including a reconfigurable functional unit, comprising:
a) reconfigurable logic circuitry;
b) instruction context storage circuitry to store instruction context information generated from instructions executed by said reconfigurable logic circuitry within said reconfigurable functional unit, said instructions including speculatively executed instructions.

2. The semiconductor chip of claim 1 wherein said reconfigurable functional unit includes a queue to store instructions issued to said reconfigurable functional unit.

3. The semiconductor chip of claim 2 wherein said reconfigurable functional unit includes control logic circuitry to receive commit messages that identify committed instructions.

4. The semiconductor chip of claim 3 wherein said control logic circuitry is coupled to said queue to remove committed instructions from said queue.

5. The semiconductor chip of claim 1 wherein said reconfigurable functional unit includes control logic circuitry to receive commit messages that identify committed instructions.

6. The semiconductor chip of claim 1 wherein said instruction context storage circuitry is coupled to second instruction context storage circuitry within said reconfigurable functional unit, said second instruction context storage circuitry to receive updates from said instruction context storage circuitry.

7. The semiconductor chip of claim 6 wherein said second instruction context storage circuitry only stores instruction context information of committed instructions.

8. The semiconductor chip of claim 6 wherein said reconfigurable functional unit comprises control logic circuitry and a counter, said control logic circuitry to cause said second instruction context storage circuitry to receive said updates in response to said counter reaching a preset value.

9. The semiconductor chip of claim 8 wherein said control logic circuitry causes said counter to increment in response to an instruction being executed by said reconfigurable logic circuitry.

10. The semiconductor chip of claim 8 wherein said control logic circuitry causes said counter to increment in response to a message being received that indicates an executed instruction is committed.

11. The semiconductor chip of claim 1 wherein said reconfigurable functional unit includes:
i) second instruction context storage circuitry coupled to said instruction context circuitry;
ii) commit instruction context storage circuitry coupled to said second instruction context storage circuitry and said instruction context storage circuitry; and,
iii) control logic circuitry to:
a) update said second instruction context storage circuitry with contents of said instruction context circuitry;
b) update said commit instruction context storage circuitry with committed instruction context information from said second instruction context storage circuitry;
c) update said instruction context circuitry with said committed instruction context information in response to an incorrect branch prediction.

12. A method, comprising:
receiving a speculative instruction at a reconfigurable functional unit;
executing said speculative instruction with reconfigurable logic circuitry within said reconfigurable functional unit;
updating instruction context storage circuitry within said reconfigurable functional unit to reflect execution through said speculative instruction;
receiving notification that said executing of said speculative instruction was improper; and,
updating said instruction context storage circuitry to reflect execution through an instruction that was executed by said reconfigurable logic circuitry before said speculative instruction.

13. The method of claim 12 wherein said method further comprises receiving notifications of committed instructions and incrementing a counter in response to said receiving of said notifications, and, in response to said counter reaching a preset value, updating second instruction context storage circuitry with contents of said instruction context storage circuitry, execution of said speculative instruction reflected within said contents.

14. The method of claim 13 wherein said updating includes providing contents of third instruction context storage circuitry into said instruction context circuitry.

15. The method of claim 12 wherein said method further comprises incrementing a counter in response to executing of instructions by said reconfigurable logic circuitry, and, in response to said counter reaching a preset value, updating second instruction context storage circuitry with contents of said instruction context storage circuitry, execution of said speculative instruction reflected within said contents.

16. The method of claim 15 wherein said updating includes providing contents of third instruction context storage circuitry into said instruction context circuitry.

17. A computing system, comprising:
a dynamic random access memory chip;
a processor, said processor having a functional unit comprising:
a) reconfigurable functional unit;
b) instruction context storage circuitry to store instruction context information generated from instructions executed by said reconfigurable logic circuitry within said reconfigurable functional unit, said instructions including speculatively executed instructions.

18. The computing system of claim 17 wherein said instruction context storage circuitry is coupled to second instruction context storage circuitry within said reconfigurable functional unit, said second instruction context storage circuitry to receive updates from said instruction context storage circuitry.

19. The computing system of claim 17 wherein said second instruction context storage circuitry only stores instruction context information of committed instructions.

20. The computing system of claim 17 wherein said reconfigurable functional unit comprises control logic circuitry and a counter, said control logic circuitry to cause said second instruction context storage circuitry to receive said updates in response to said counter reaching a preset value.
